(19) United States
(12) Patent Application Publication
(10) Pub. No.: US 2013/0062948 A1
(43) Pub. Date: Mar. 14, 2013

(54) MULTIPLE-INPUT DRIVING DEVICE

(71) Applicants: HUAI-KU CHUNG, New Taipei City (TW); Jiun-Cheng Liao, New Taipei City (TW)

(72) Inventors: HUAI-KU CHUNG, New Taipei City (TW); Jiun-Cheng Liao, New Taipei City (TW)

(21) Appl. No.: 13/228,415

(22) Filed: Sep. 8, 2011

(51) Int. Cl. H02J 4/00

(52) U.S. Cl. 307/52

(57) ABSTRACT

The present invention relates to a multiple-input driving device, which receives at least one electrical power that shows a voltage. The multiple-input driving device uses interaction among a voltage regulation module, a control module, and a conversion module to simultaneously the functions of voltage regulation, input through pushbutton switch, driving a light-emitting diode with regulated power or driving the light-emitting diode with input of pulse width modulated power.

### (a) TECHNICAL FIELD OF THE INVENTION

The present invention generally relates to a driving device of electrical appliance, and more particularly to a multiple-input driving device that provides the functions of voltage regulation, input through pushbutton switch, driving light-emitting diode with regulated power, and/or driving light-emitting diode with input of pulse width modulated power.

### (b) DESCRIPTION OF THE PRIOR ART

An in-car electrical appliance must be operated with a driving device. However, the conventional driving device for in-car electrical appliances is often of a specific and single function, for example regulation of voltage or stabilization of power supplied to a light-emitting diode the electrical power or providing input through pushbutton switch input function, or providing an input of pulse width modulated electrical power for driving a light-emitting diode. The known driving devices are of no features integrating all these functions.

Apparently, the conventional driving device shows several drawbacks and deficiencies in the use thereof. For example, the conventional driving device does not integrate the functions of voltage regulation, stabilization of electrical power for driving light-emitting diode, input through pushbutton switch, and input of pulse width modulated electrical power for driving light-emitting diode all in the same single driving device.

### SUMMARY OF THE INVENTION

The primary objective of the present invention is to provide a solution for integrating all the functions of voltage regulation, stabilization of electrical power for driving light-emitting diode, input through pushbutton switch, and driving light-emitting diode with input of pulse width modulated power in a single driving device, so as to realize a practical improvement that simultaneously achieve the functions of voltage regulation, input through pushbutton switch, driving light-emitting diode with regulated power, and driving light-emitting diode with input of pulse width modulated power

To achieve the above objective, the present invention provides a multiple-input driving device, which receives at least one electrical power. The electrical power has at least one voltage. The multiple-input driving device comprises: a voltage regulation module, a control module, and a conversion module, wherein the voltage regulation module comprises a voltage limiting unit that receives the first electrical power and limits the upper bound level of the first voltage. The voltage limiting unit is electrically connected a voltage conversion unit that converts the first voltage into a second voltage and supplies at least second electrical power. The second electrical power drives an electrical appliance that is electrically connected to the voltage conversion unit. The control module is electrically connected to the voltage regulation module. The control module comprises a pushbutton control unit that receives a control signal and eliminates the bounce phenomenon. The control signal is generated by a switch module. The switch module is in information connection with the control module. The pushbutton control unit converts the control signal into a control instruction and a control status value. A status relay unit transmits the control instruction to the conversion module and the status relay unit transmits the control status value to an external display device. The conversion module is in information connection with the control module in order to receive the control instruction. The conversion module comprises a second voltage limiting unit. The second voltage limiting unit receives third electrical power generated by a pulse width modulation (PWM) control unit. The PWM control unit is electrically connected to the second voltage limiting unit. The second voltage limiting unit limits a pulse width modulated third voltage of the third electrical power. The second voltage limiting unit is electrically connected to a constant current conversion unit. The constant current conversion unit is electrically connected to the second voltage limiting unit and the constant current conversion unit is in information connection with the control module in order to receive the control instruction. The constant current conversion unit is electrically connected to a current setting unit that is connected to an externally-connected electrical resistor. The current setting unit converts the third electrical power into fourth electrical power, and the fourth electrical power is transmitted by the constant current conversion unit as an output so that the fourth electrical power drives at least one light-emitting diode that is electrically connected to the constant current conversion unit.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a preferred embodiment of the present invention.

FIG. 2 is a block diagram illustrating an application of the preferred embodiment of the present invention.

FIG. 3 is a perspective view illustrating an application of the preferred embodiment of the present invention.

FIG. 4 is a perspective view illustrating another application of the preferred embodiment of the present invention.

FIG. 5 is a perspective view illustrating an operation of another preferred embodiment of the present invention.

FIG. 5a is a partial enlarged view illustrating the operation of said another preferred embodiment of the present invention.

FIG. 6 is a perspective view illustrating an operation of a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

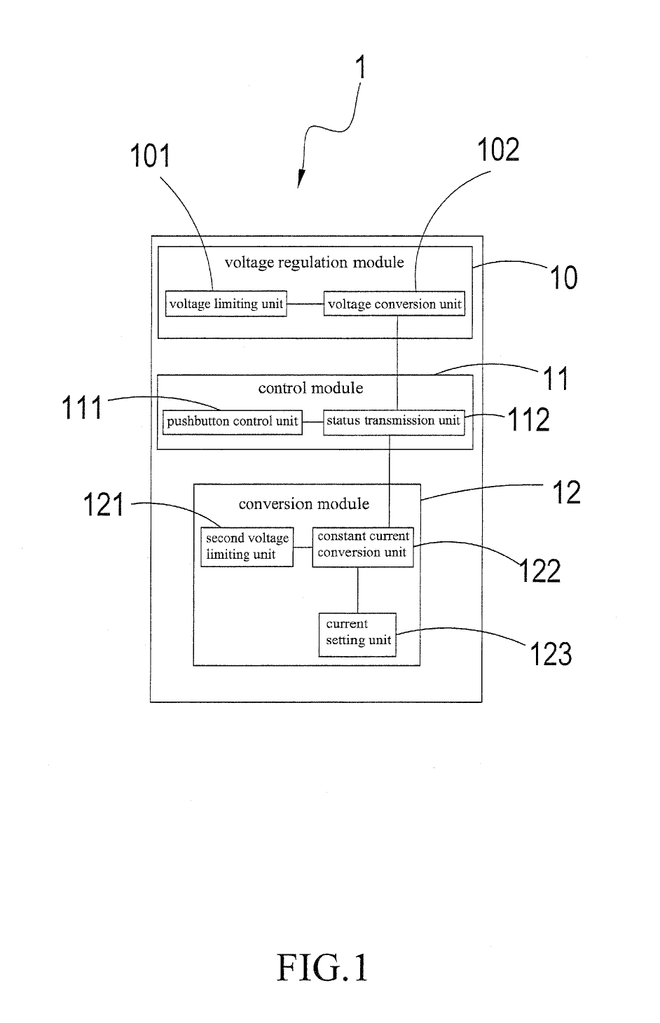

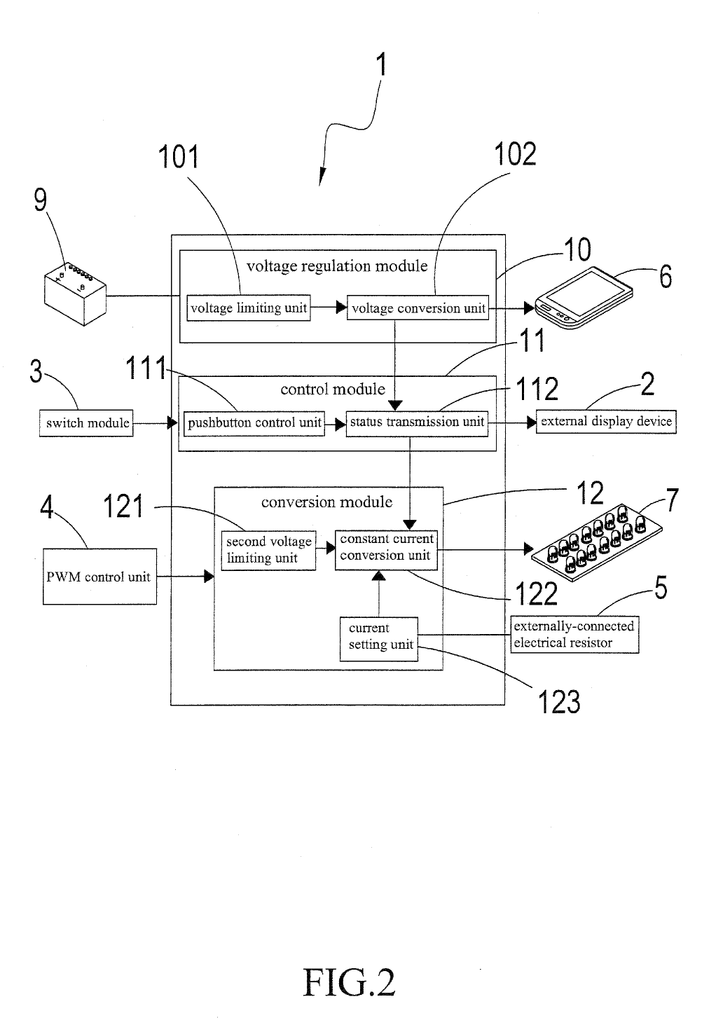

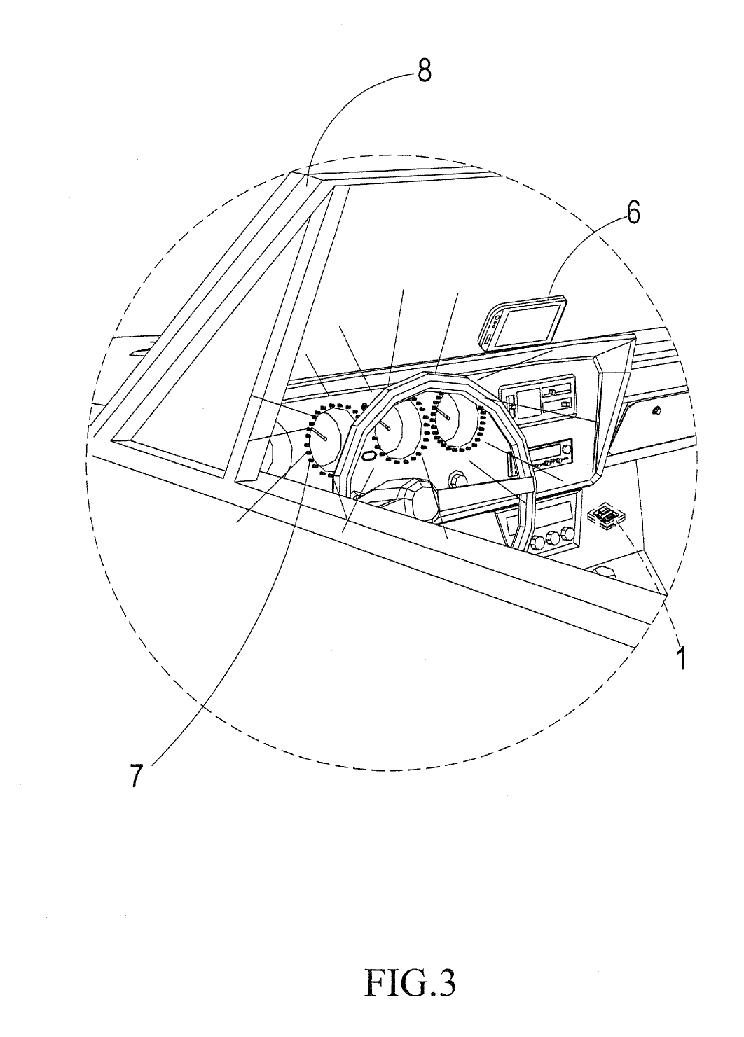

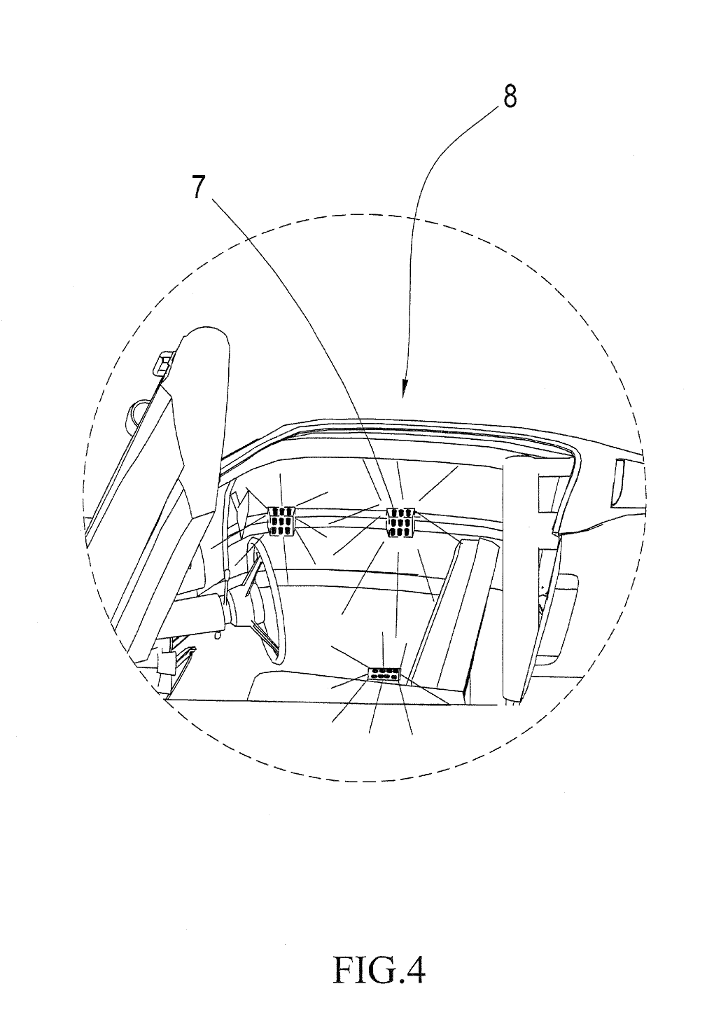

Referring to FIGS. 1, 2, 3, and 4, which are respectively a perspective view of a preferred embodiment of the present invention, a block diagram illustrating an application of the preferred embodiment of the present invention, a perspective view illustrating an application of the preferred embodiment of the present invention, and a perspective view illustrating another application of the preferred embodiment of the present invention, these drawings clearly show that the present invention provides a multiple-input driving device, which receives at least one electrical power 9. The electrical power 9 provides at least one voltage. The device comprises: a voltage regulation module 10, a control module 11, and a conversion module 12. The voltage regulation module 10 comprises a voltage limiting unit 101 that receives the first electrical power and limits the upper bound level of the first voltage. The voltage limiting unit 101 is electrically connected a voltage conversion unit 102 that converts the first voltage into a second voltage and supplies at least second electrical power. The second electrical power drives an electrical appliance 6 that is electrically connected to the voltage conversion unit 102. The control module 11 is electrically connected to the voltage regulation module 10. The control module 11 comprises a pushbutton control unit 111 that receives a control signal and eliminates the bounce phenomenon. The control signal is generated by a switch module 3. The switch module 3 is in information connection with the control module 11. The pushbutton control unit 111 converts the control signal into a control instruction and a control status value. A status relay unit 112 transmits the control instruction to the conversion module 12 and the status relay unit 112 transmits the control status value to an external display device 2. The conversion module 12 is in information connection with the control module 11 in order to receive the control instruction. The conversion module 12 comprises a second voltage limiting unit 121. The second voltage limiting unit 121 receives third electrical power generated by a pulse width modulation (PWM) control unit 4. The PWM control unit 4 is electrically connected to the second voltage limiting unit 121. The second voltage limiting unit 121 limits a pulse width modulated third voltage of the third electrical power. The second voltage limiting unit 121 is electrically connected to a constant current conversion unit 122. The constant current conversion unit 122 is electrically connected to the second voltage limiting unit 121, and the constant current conversion unit 122 is in information connection with the control module 11 in order to receive the control instruction. The constant current conversion unit 122 is electrically connected to a current setting unit 123 that is connected to an externally-connected electrical resistor 5. The current setting unit 123 converts the third electrical power into fourth electrical power, and the fourth electrical power is transmitted by the constant current conversion unit 122 as an output. The fourth electrical power drives at least one light-emitting diode 7 that is electrically connected to the constant current conversion unit 122.

With the above arrangement of structure, an explanation will be given to an operation performed by the present invention. The multiple-input driving device 1 is applicable to for example an electrical appliance 6 that is arranged in an automobile 8 to provide the following functions of voltage regulation, input through pushbutton switch, driving light-emitting diode with regulated power, and driving light-emitting diode with pulse width modulated power, which will be sequentially explained as follows.

### Voltage Regulation

The voltage regulation module 10 included in the present invention comprises the voltage limiting unit 101 that receives the first electrical power that is direct current and limits the upper bound level of the first voltage, whereby the voltage limiting unit 101 filters out excessively high voltage that cannot be taken by the circuit. Further, the voltage limiting unit 101 is electrically connected to the voltage conversion unit 102 that converts the first voltage into the second voltage and outputs the second electrical power. The second electrical power is then used to drive the electrical appliance 6 that is electrically connected to the voltage conversion unit 102. As such, the voltage regulation module 10 converts an input voltage into a voltage that is applicable to the electrical appliance 6.

Input through Pushbutton Switch

The control module 11 according to the present invention is electrically connected to the voltage regulation module 10, and thus the control module 11 is supplied with the second electrical power by the voltage regulation module 10. The control module 11 comprises the pushbutton control unit 111 that receives the control signal and eliminates the bounce phenomenon. The control signal is generated by the switch module 3. The switch module 3 is in information connection with the control module 11. The pushbutton control unit 111 converts the control signal into a control instruction and a control status value. The status relay unit 112 transmits the control instruction to the conversion module 12, and the status relay unit 112 transmits the control status value to the external display device 2.

Driving Light-Emitting Diode with Regulated Power

The second electrical power supplied from the voltage regulation module 10 is transmitted through the control module 11, so that when the control module 11 is switched to form an electrical circuit with the constant current conversion unit 122, the constant current conversion unit 122 and the current setting unit 123 that is connected to the externally-connected electrical resistor 5 may supply a regulated, stable second electrical power for driving at least one light-emitting diode 7.

Driving Light-Emitting Diode with Pulse Width Modulated Power

The conversion module 12 according to the present invention is in information connection with the control module 11 to receive the control instruction. The conversion module 12 comprises the second voltage limiting unit 121, and the second voltage limiting unit 121 receives the third electrical power generated by the PWM control unit 4. The third electrical power is direct current. The PWM control unit 4 is electrically connected to the second voltage limiting unit 121, and the second voltage limiting unit 121 limits the pulse width modulated third voltage of the third electrical power. The second voltage limiting unit 121 is electrically connected to the constant current conversion unit 122. The constant current conversion unit 122 is electrically connected to the second voltage limiting unit 121, and the constant current conversion unit 122 is in information connection with the control module 11 to receive the control instruction. The constant current conversion unit 122 is electrically connected to the current setting unit 123 that is connected to the externally-connected electrical resistor 5. The current setting unit 123 converts the third electrical power into the fourth electrical power, and the fourth electrical power is transmitted by the constant current conversion unit 122 as an output. The fourth electrical power drives at least one light-emitting diode 7 that is electrically connected to the constant current conversion unit 122.

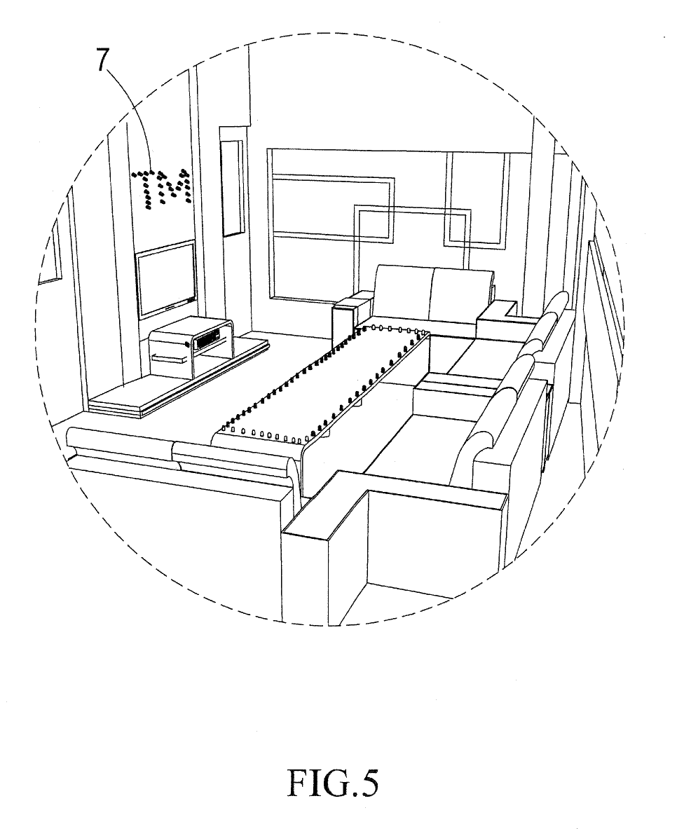

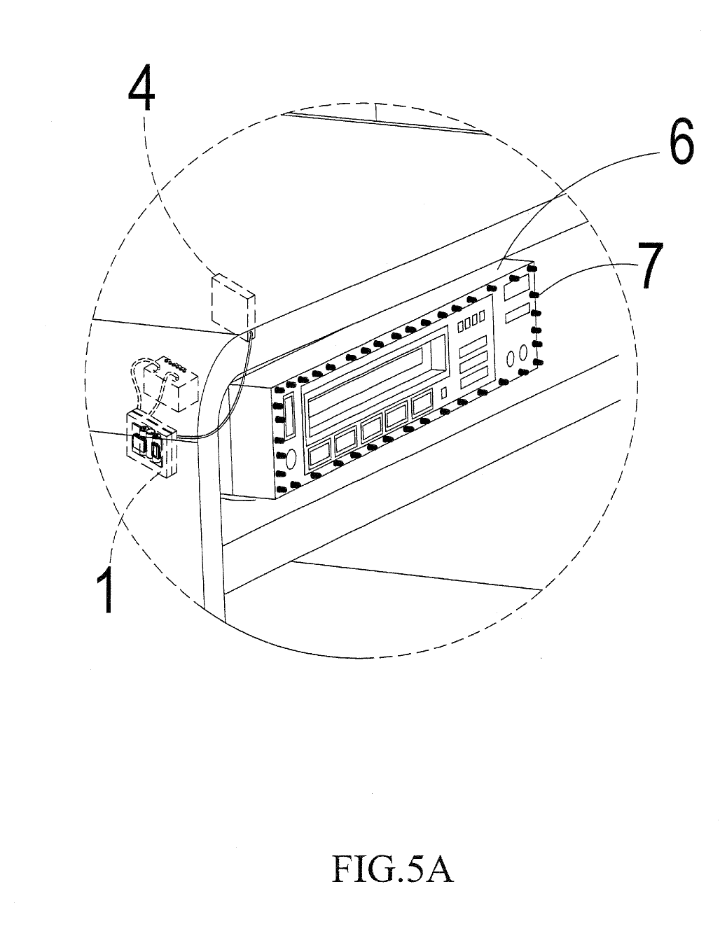

Also referring to FIGS. 5 and 5a, which are respectively a perspective view illustrating an operation of another preferred embodiment of the present invention and a partial enlarged view illustrating the operation of said another preferred embodiment of the present invention, these drawings clearly show that the multiple-input driving device 1 is also applicable for generating a desired indoor atmosphere by using the multiple-input driving device 1 to drive the electrical appliance 6 and at least one light-emitting diode 7 to realize generation of the desired atmosphere.

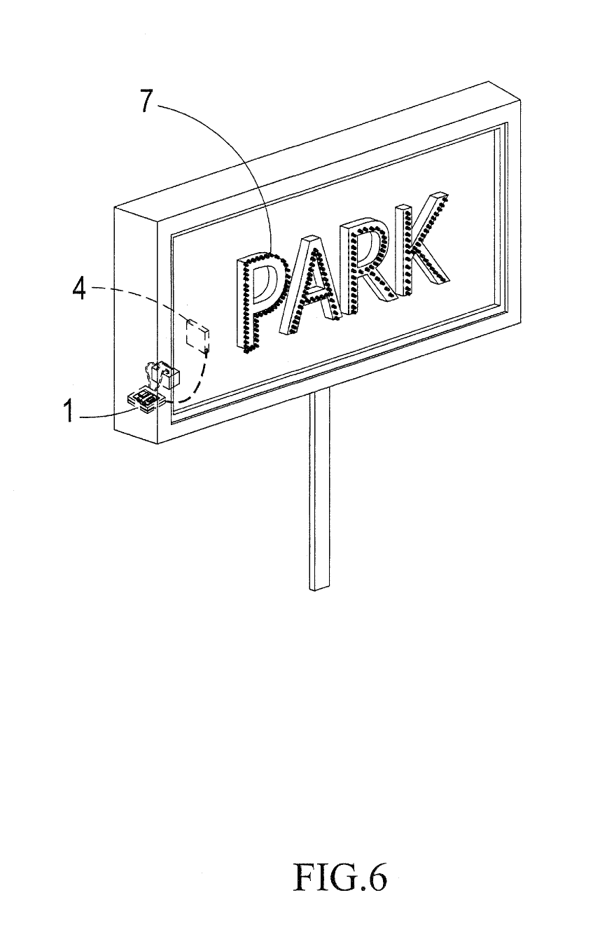

Also referring to FIG. 6, which is a perspective view illustrating an operation of a further embodiment of the present invention, the drawing clearly shows that the multiple-input driving device 1 is also applicable for generating a desired outdoor atmosphere by using the multiple-input driving device 1 to drive the electrical appliance 6 and at least one light-emitting diode 7 to realize generation of the desired atmosphere and highlighting of signboard for eye catching.

In summary, the present invention, when put into use, shows the following advantages:

(1) The present invention combines the functions of voltage regulation, input through pushbutton switch, driving a light-emitting diode 7 with regulated power, and driving a light-emitting diode 7 with pulse width modulated input power in a single device.

(2) The present invention provides a one-piece device through proper integration so that the installation is simplified, energy consumption is reduced, and cost is saved.

(3) Due to the function of voltage regulation and simplified circuit, safety and security of an automobile 8 are enhanced.

(4) Besides being used to drive an electrical appliance 6 inside an automobile 8, the present invention is also helpful in generating a desired indoor atmosphere and making a signboard eye catching.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multiple-input driving device, which receives at least one electrical power, the electrical power having at least one voltage, the device comprising:
a voltage regulation module, which receives the first electrical power and limits an upper bound level of the first voltage, the voltage regulation module converting the first voltage into a second voltage and outputting at least one second electrical power;
a control module, which is electrically connected to the voltage regulation module, the control module receiving a control signal and outputting a control instruction and a control status value; and
a conversion module, which is in information connection with the control module to receive the control instruction, the conversion module receiving a pulse width modulated third electrical power and converting the third electrical power into a constant fourth electrical power.

2. The multiple-input driving device according to claim 1, wherein the voltage regulation module comprises:
a voltage limiting unit, which receives the first electrical power and limits the upper bound level of the first voltage; and
a voltage conversion unit, which is electrically connected to the voltage limiting unit and converts the first voltage into the second voltage and supplies the at least one second electrical power.

3. The multiple-input driving device according to claim 2, wherein the second electrical power drives an electrical appliance that is electrically connected to the voltage conversion unit.

4. The multiple-input driving device according to claim 1, wherein the control module comprises:
a pushbutton control unit, which receives the control signal and eliminates bounce phenomenon, the pushbutton control unit converting the control signal into the control instruction and the control status value; and
a status relay unit, which transmits the control instruction to the conversion module.

5. The multiple-input driving device according to claim 4, wherein the status relay unit transmits the control status value to an external display device.

6. The multiple-input driving device according to claim 1, wherein the conversion module comprises:
a second voltage limiting unit, which receives the third electrical power and limits a pulse width modulated third voltage of the third electrical power;
a constant current conversion unit, which is electrically connected to the second voltage limiting unit and is in information connection with the control module to receive the control instruction; and
a current setting unit, which is connected to an externally-connected electrical resistor, the current setting unit being electrically connected to the constant current conversion unit, the third electrical power being converted by the current setting unit into the fourth electrical power.

7. The multiple-input driving device according to claim 6, wherein the fourth electrical power is transmitted by the constant current conversion unit as an output.

8. The multiple-input driving device according to claim 6, wherein the fourth electrical power drives at least one light-emitting diode that is electrically connected to the constant current conversion unit.

9. The multiple-input driving device according to claim 1, wherein the third electrical power is generated by a pulse width modulation control unit, which is electrically connected to the second voltage limiting unit.

10. The multiple-input driving device according to claim 1, wherein the control signal is generated by a switch module, which is in information connection with the control module.
